(19) United States
(12) Patent Application Publication
(10) Pub. No.: US 2025/0091411 A1
(43) Pub. Date: Mar. 20, 2025

(54) Elastocaloric Element for a Temperature Control System

(71) Applicant: Volkswagen Aktiengesellschaft, Wolfsburg (DE)

(72) Inventors: Christian Schneck, Braunschweig (DE); Jürgen Olfe, Volkse (DE)

(73) Assignee: Volkswagen Aktiengesellschaft, Wolfsburg (DE)

(21) Appl. No.: 18/688,460

(22) PCT Filed: Jul. 19, 2022
(86) PCT No.: PCT/EP2022/070189

§ 371 Date: Dec. 6, 2024

(30) Foreign Application Priority Data
Sep. 2, 2021 (DE) 10 2021 209 664.6

(51) Int. Cl. B60H 1/32; F25B 23/00

(52) U.S. Cl. CPC B60H 1/32; F25B 23/00; B60H 2001/3286

(57) ABSTRACT

The disclosure relates to an elastocaloric element for a temperature control system, wherein the elastocaloric element comprises an elastic carrier and a coating applied to the carrier, wherein the carrier consists at least partly of a plastic and the coating consists at least partly of an elastocaloric material.

### CROSS-REFERENCE TO RELATED APPLICATIONS

This application claims priority to German Patent Application No. DE 10 2021 209 664.6, filed on Sep. 2, 2021 with the Trademark Office. The contents of the German Patent and aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an elastocaloric element for a temperature control system, a temperature control system, and a motor vehicle with a temperature control system.

The elastocaloric effect, which ordinarily causes a reversible temperature change through cyclical deformation of an elastocaloric material in the strain range of 18-5% (compression or tension), can be used technically for temperature control. The elastocaloric material heats up when it is compressed and cools down again to the original temperature when it is subsequently stretched. Through cyclical dissipation of the heat on the elastocaloric material, the effect can be used for said temperature control, in particular climate control in the form of cooling or heating.

Elastocaloric materials are, in this case, metal alloys with an elastocaloric effect, which naturally have a high modulus of which is why elasticity and are therefore relatively stiff, large forces, moments, or electrical currents must ordinarily be applied in order to achieve a technically usable effect in the form of a sufficiently high thermal output.

In order to achieve high thermal outputs with a simultaneously low use of elastocaloric material, the surface of the elastocaloric material should be as large as possible so that the heat can be dissipated to the environment quickly as possible. If the heat is dissipated quickly, the system frequency of the temperature control system can be selected to be high.

Solutions for cyclical operation of the elastocaloric material exist for tensile and compressive load. In the case of operation of the elastocaloric material under compressive load, solutions with hollow rods as elastocaloric elements are envisioned, which are manufactured from the elastocaloric material. The compressive load results in the benefit of higher durability. At the same time, the elastocaloric material must also be used for the stabilizing shape in addition to the heat generation, such that the rods must be designed with a sufficiently thick wall thickness in order not to bend under compressive load. The greater wall thickness compared to the solution with the wires leads to a slower dissipation of heat from the elastocaloric material, such that higher frequencies can only be reached with poorer efficiency. The material needed for this version is increased accordingly.

### SUMMARY

A need exist to provide an elastocaloric element that has a high durability under cyclical load.

The need is addressed by the subject matter of the independent claim(s). Embodiments of the invention are described in the dependent claims, the following description, and the drawings.

The element may in some embodiments allow for an increased operating frequency, an improved heat transfer when used in a temperature control system, and may only require a small amount of elastocaloric material.

### BRIEF DESCRIPTION OF THE DRAWINGS

FIG. 1 shows a perspective view of an elastocaloric element according to a first example embodiment;

FIG. 2 shows a cross-sectional view of an elastocaloric element according to a second example embodiment;

FIG. 3 shows a cross-sectional view of an elastocaloric element according to a third example embodiment;

FIG. 4 shows a cross-sectional view of an elastocaloric element according to a fourth example embodiment;

FIG. 5 shows a cross-sectional view of an elastocaloric element according to a fifth example embodiment;

FIG. 6 shows a perspective view of an elastocaloric element according to a sixth example embodiment;

FIG. 7 shows a front view of an elastocaloric element according to a seventh example embodiment;

FIG. 8 shows a perspective view of an elastocaloric element according to an eighth example embodiment; and

FIG. 9 shows a schematic view of a motor vehicle with a temperature control system according to an example embodiment.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

It is noted that embodiments and details that are disclosed in association with the elastocaloric material also apply in association with the temperature control system and the motor vehicle described herein, and vice versa.

According to some embodiments, an elastocaloric element for an elastocaloric temperature control system is provided, wherein the elastocaloric element comprises an elastic carrier and a coating applied to the carrier, wherein the carrier consists at least partly of a plastic and the coating consists at least partly of an elastocaloric material.

Compared to the complete formation of the elastocaloric element from elastocaloric material, the at least partial formation of the elastocaloric material with a carrier made of plastic enables only one thin) (in particular coating with the elastocaloric material and thus a considerable increase in the durability of the elastocaloric material under cyclical load at high strain (>1% or >2%). Furthermore, an increase in the operating frequency as a result of the low layer thickness of the elastocaloric material, which is provided by introducing the carrier with plastic compared to the known solutions, is enabled. An improved heat transfer to the environment can also be enabled, which enables more efficient operation of the elastocaloric element. Elastocaloric material can also be saved in the elastocaloric element, as will be explained in more detail with reference to the layer thickness of the elastocaloric material. This leads to reductions in weight and cost when using and producing the elastocaloric element.

Especially, due to the use of plastic in or as the carrier, the elastocaloric material can be applied to the carrier in a thickness that is, for example, up to 10 times lower, for instance 20 μm than is the case in today's solutions, for instance with the wires made of elastocaloric material with diameters of over 200 μm. This reduces the amount of material needed and improves the heat transfer such that less caloric material can be operated with a higher system frequency with the same thermal output as in known solutions. Another benefit was identified in the higher durability of thin layers made of elastocaloric material with layer thicknesses of, for example, less than 50 μm and in the more robust design that is possible. In the case of the known solution with the thin wires, a tear would most likely lead to a complete failure of the machine. A tear in the elastocaloric layer of the elastocaloric element of this disclosure on the coating, however, leads only to an inhibition of the caloric effect in a local region and thus only to a small reduction in the thermal output but not to the failure of the temperature control system.

The carrier being elastic means that it can be elastically deformed up to a certain degree, in particular reversibly elastically deformed at large strains of >1%, >5% or even >10%, without a plastic deformation taking place. In other words, the carrier can be reversibly deformed by the action of force. The elastic properties of the carrier can be provided by the selection of the plastic. For example, an elastomer, a thermoplastic, or another polymer, which for example has the elastic properties indicated above, can be selected as the plastic. Combinations of different, in particular of the aforementioned, elastic plastics are also possible. The elastic plastic has an, in some cases significantly, higher reversible deformability than elastocaloric materials. As a result, they can be reversibly stretched unproblematically over a relevant strain range of approx. 1%-5% without being destroyed. Another benefit of the use of the plastic is that the plastic has a low thermal conduction coefficient. As a result, the carrier is thermally insulating. In addition, the carrier thus has a density that is many times lower compared to metal alloys. In particular, the carrier can consist of only one plastic or multiple plastics.

The coating can in particular have a constant layer thickness or, respectively, thickness. The coating can in particular be formed along an entire or nearly entire outer (lateral) surface of the carrier. Accordingly, the coating can be designed as a coating running around the carrier. Beneficially, a particularly high degree of surface utilization of the carrier is thus achieved with the coating, allowing as much coating as possible to be applied to the carrier with a low layer thickness and increasing the thermal output as a result without issues with regard to durability. In addition to the elastocaloric material, other components can be provided in the coating. In particular, the coating can accordingly consist of only one or more, for example two or three, different elastocaloric materials.

The temperature control system described herein is a system for temperature control of a structure or a space. The temperature control system can also be referred to as a climate control system or an air conditioning system. In this sense, temperature control or climate control that can comprise the possibilities of cooling and heating can be provided by means of the system.

In particular, the coating can have a layer thickness of up to 200 μm. Especially, the layer thickness of the coating can be up to 150 μm, further especially up to 100 μm, even more particularly up to 80 μm or up to 50 μm. Especially, the coating can have a layer thickness in the range from 5 μm to 100 μm, in particular in the range from 7 μm to 80 μm, and further particularly in the range from 10 μm to 50 μm. Such small layer thicknesses are enabled by the elastic carrier, which provides the elasticity necessary the the for deformation of elastocaloric element so that it can be purely elastically or, in other words, reversibly deformed along with the coating up to a certain degree that is necessary for the operation of the temperature control system. It has been shown that, surprisingly, a high thermal output can be provided for the temperature control system with such small layer thicknesses in combination with the elastic carrier without needing to use too much elastocaloric material for the coating, such that costs and weight of the elastocaloric element can be considerably reduced compared to the known elastocaloric elements. This is especially important for applications in temperature control systems of motor vehicles, since the quantities are very large.

In particular, the carrier can be reversibly stretchable up to an elastic limit of at least 2%, especially at least 3%, and further particularly at least 5%. This quantification of the elastic properties of the carrier implies that the carrier is designed such that it can be usefully used along with the coating located thereon in a temperature control system. In this case, it can be elastically deformed or, in other words, stretched to the required minimum extent, whereby the coating located thereon is also deformed and can provide the required thermal output of the temperature control system.

Especially, the elastocaloric material can be a shape memory alloy. If there are multiple elastocaloric materials in the coating, different shape memory alloys can be used. Shape memory alloys have two different crystal structures, which are temperature-dependent. The phase change in shape memory alloys is based on a temperature-dependent lattice transformation to one of the two crystal structures. There is typically the high-temperature phase, called austenite, and the low-temperature phase, called martensite. Both can transition into each other through deformation. The associated temperature change is used in the temperature control system for the desired temperature control, either cooling or heating. Any materials, in particular shape memory alloys, that exhibit the elastocaloric effect can be used for this. For example, an NiTi alloy (nickel-titanium, nitinol), which has a pronounced elastocaloric effect that enables a large temperature increase, can be used as the shape memory alloy. However, the use of, for example, copper-based alloys such as CuZn (copper-zinc), CuAlNi (copper-aluminum-nickel), or CuZnAl (copper-zinc-aluminum) as the shape memory alloy is also possible. The use of FeNiAl (iron-nickel-aluminum), FeMnSi (iron-manganese-silicon), and ZnAuCu (zinc-gold-copper) as the shape memory alloy is also possible.

The carrier can be formed as a carrier body with a cross-section. The cross-section can be at least predominantly constant. The cross-section can accordingly be constant along a predominant partial length of the carrier body or the entire or nearly entire length of the carrier body. Alternatively, however, the cross-section can also not be constant. In this case, the cross-section of the carrier body can be, for example, circular or oval. It can be designed as a solid profile. However, to increase flexibility of the carrier and reduce the weight, designing the carrier body with a hollow profile is also possible. Overall, flexibility can be increased not only by different material selection for the carrier but also by its shape. A constant cross-section can be manufactured very simply, as a result of which the production costs can be lowered further.

Especially, the cross-section of the carrier or, respectively, carrier body, which can be at least predominantly constant or, alternatively, not constant or only constant in portions, can be ring-shaped, star-shaped, or cross-shaped. With a ring-shaped cross-section, the aforementioned hollow profile can be achieved, as a result of which the weight of the elastocaloric element can be reduced further. A star-shaped or cross-shaped cross-sectional design also enables a reduction in weight and increase in flexibility for deforming the elastocaloric element. Also conceivable are combinations of the mentioned cross-sectional shapes and modified or further cross-sectional shapes that have in common that they provide a surface of the elastocaloric element that is as large as possible with the lowest possible manufacturing effort while simultaneously requiring a small amount of space.

It is also possible that the carrier is formed as a spring. In other words, the carrier can be designed in the shape of a spring. It is possible, for example, to form the carrier as a spiral spring, a cup spring, or a helical spring.

According to some embodiments, a temperature control system is provided with an elastocaloric element according to the teachings herein.

The temperature control system can, in particular, be a temperature control system for a motor vehicle. The temperature control system can be an air conditioner, heat pump, or the like in the vehicle or be part of one of the aforementioned units or, respectively, systems.

As discussed previously, elastocaloric materials can take on two different crystal structures. In the temperature control system, a mechanical tension is generated in the elastocaloric element by the application of pressure or the like, as a result of which a crystal phase transformation of the coating or, respectively, the elastocaloric material occurs, wherein the elastocaloric material or, respectively, the coating of the elastocaloric element heats up from a starting temperature to an increased temperature. The resulting heat is dissipated by a heat sink of the temperature control system and the temperature of the elastocaloric material or, respectively, the coating falls back to the starting temperature or to a slightly higher temperature as a result. If the mechanical tension is now removed, the elastocaloric material or, respectively, the coating cools down to a lowered temperature below the starting level. The elastocaloric material can now be connected to a location to be cooled of the temperature control system, such that the system absorbs heat until the starting temperature is reached. Also or alternatively, the dissipation of heat is possible through a refrigerant mass flow, for example, air, a water-glycol mixture, or the like, which is then conducted to the structure to the cooled, in a vehicle, for example, a battery, and/or to the space to be cooled, in a vehicle, for example, a passenger cabin. Through such a cyclical loading and unloading of the elastocaloric element and thus the coating in the temperature control system and corresponding heat dissipation, a cycle can be produced in the temperature control system. The temperature control system with the elastocaloric element can thus be designed as an efficient heat pump for cooling or heating that dispense with refrigerants.

According some embodiments, a motor vehicle is provided with the temperature control system according to the teachings herein.

Reference will now be made to the drawings in which the various elements of embodiments will be given numerical designations and in which further embodiments will be discussed.

Elements with the same function and mode of operation have been provided with the same reference signs in each of FIGS. 1 to 9.

FIG. 1 shows an elastocaloric element 1. The elastocaloric element 1 has a carrier 2, which is formed in the present case by way of example as a cylindrical carrier body with a solid profile. The carrier 2 is formed from a plastic, for example, an elastomer. Accordingly, the carrier 2 is endowed with elastic properties.

A coating 3 is applied to the carrier 2. In the present case, the coating 3 is applied to the entire outer lateral surface of the carrier 2. The coating 3 consists of an elastocaloric material, in particular a shape memory alloy, such as a nickel-titanium alloy. The coating 3 can have a relatively small layer thickness in the range from, for example, 10 μm to 50 μm. The layer thickness can be constant in this case.

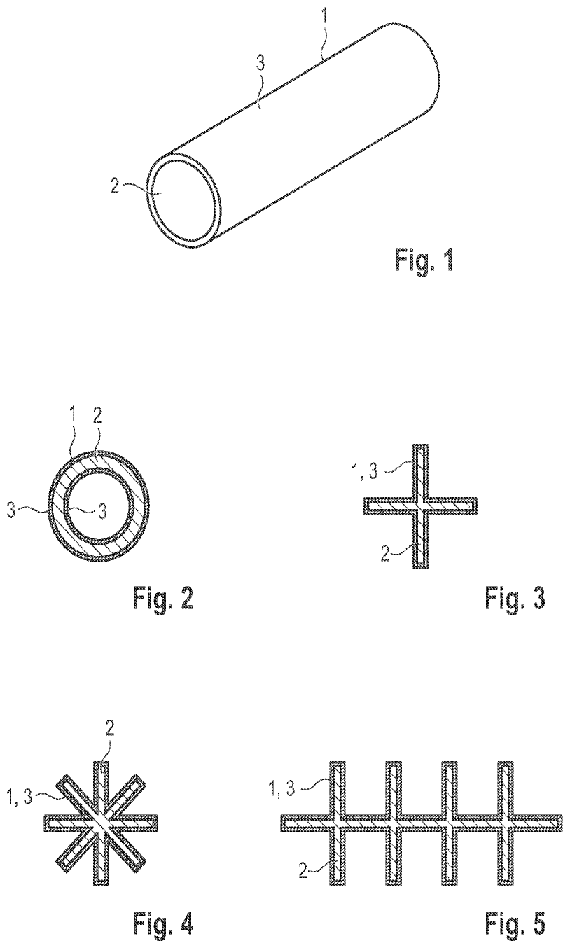

FIGS. 2 to 5 show elastocaloric elements 1, which can resemble the elastocaloric element 1 from FIG. 1 in the structure composed of carrier 2 and coating 3 with the material selection and layer thickness of the coating 3. However, the elastocaloric elements 1 from FIGS. 2 to 5 have cross-sectional shapes of the elongated carrier body that differ from the elastocaloric element 1 from FIG. 1. The cross-sections are in each case constant over the length of the carrier 2 or, respectively, elastocaloric element 1.

The elastocaloric element 1 from FIG. 2 is thus formed with a ring-shaped cross-section. The carrier 2 is formed as a hollow profile. The coating 3 is applied to the outer and inner lateral surface. This increases the area of the coating 3 compared to the embodiment from FIG. 1.

The elastocaloric element 1 from FIG. 3 is formed with a cross-shaped cross-section. The elastocaloric element 1 from FIG. 4 in turn is formed with a star-shaped cross-section, in which the area of the coating 3 is in turn increased compared to that from FIG. 3. FIG. 5 shows an elastocaloric element 1 with a repeating cross-shaped cross-section. Here, the carrier 2 is formed in cross-section with multiple adjacent or, in other words, attached cross-shaped cross-sections.

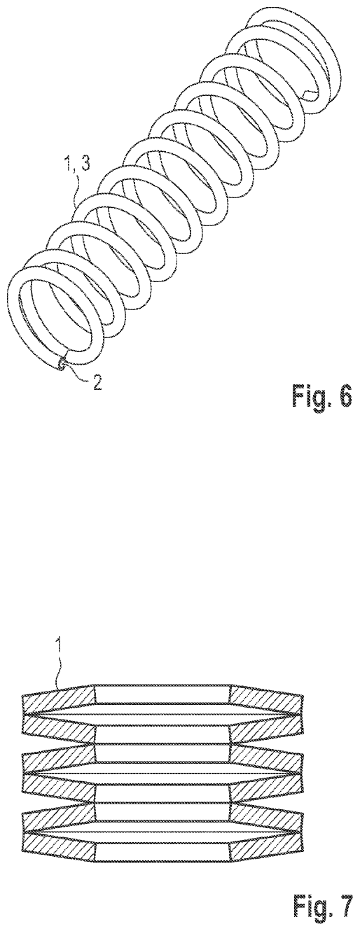

FIGS. 6 to 8 show elastocaloric elements 1, which can resemble the elastocaloric element 1 from FIG. 1 in the structure composed of carrier 2 and coating 3 with the material selection and layer thickness of the coating 3. However, the elastocaloric elements 1 from FIGS. 6 to 8 have cross-sectional shapes of the carrier body that differ from the elastocaloric element 1 from FIG. 1.

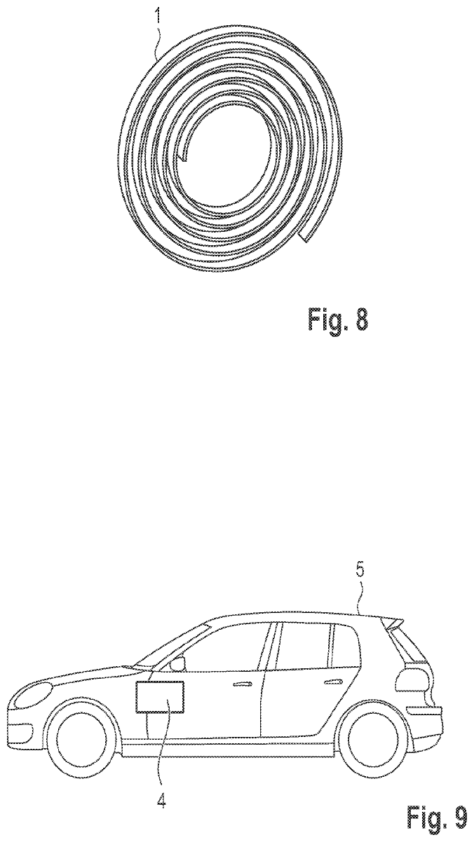

The elastocaloric element 1 from FIG. 6 is thus formed as a helical spring. The elastocaloric element 1 from FIG. 7 is formed as a cup spring and the elastocaloric element 1 from FIG. 8 is formed as a spiral spring.

Finally, FIG. 9 shows, purely schematically, a motor vehicle 5, in which a temperature control system 4 that uses the of the exemplary elastocaloric element 1 according to one 41 embodiments from FIGS. 1 to 8 is provided. The temperature control system 4 can be designed in particular as a heat pump. The temperature control system 4 utilizes the elastocaloric properties of the elastocaloric element 1 during deformation of the elastocaloric element 1 and thus of the coating 3 located thereon with the elastocaloric properties and can dispense with refrigerants as a result.

### LIST OF REFERENCE NUMERALS

1 Elastocaloric element
2 Carrier
3 Coating
4 Temperature control system
5 Motor vehicle

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. An elastocaloric element for a temperature control system, wherein the elastocaloric element comprises an elastic carrier and a coating applied to the carrier, wherein the carrier consists at least partly of a plastic and the coating consists at least partly of an elastocaloric material.

12. The element of claim 11, wherein the coating has a layer thickness of up to 200 μm.

13. The element of claim 11, wherein the coating has a layer thickness in the range from 5 μm to 100 μm.

14. The element of claim 11, wherein the carrier is reversibly stretchable up to an elastic limit of at least 2%.

15. The element of claim 11, wherein the elastocaloric material is a shape memory alloy.

16. The element of claim 11, wherein the carrier is formed as a carrier body with an at least predominantly constant cross-section.

17. The element of claim 11, wherein the carrier is formed with a ring-shaped, star-shaped, or cross-shaped cross-section.

18. The element of claim 11, wherein the carrier is formed as a spring.

19. A temperature control system having an elastocaloric element, comprising:
an elastic carrier and a coating applied to the carrier, wherein the carrier consists at least partly of a plastic and the coating consists at least partly of an elastocaloric material.

20. The temperature control system of claim 19, wherein the coating has a layer thickness of up to 200 μm.

21. The temperature control system of claim 19, wherein the coating has a layer thickness in the range from 5 μm to 100 μm.

22. The temperature control system of claim 19, wherein the carrier is reversibly stretchable up to an elastic limit of at least 2%.

23. The temperature control system of claim 19, wherein the elastocaloric material is a shape memory alloy.

24. The temperature control system of claim 19, wherein the carrier is formed as a carrier body with an at least predominantly constant cross-section.

25. The temperature control system of claim 19, wherein the carrier is formed with a ring-shaped, star-shaped, or cross-shaped cross-section.

26. The temperature control system of claim 19, wherein the carrier is formed as a spring.

27. A motor vehicle having a temperature control system, comprising an elastocaloric element, the elastocaloric element comprising:
an elastic carrier and a coating applied to the carrier, wherein the carrier consists at least partly of a plastic and the coating consists at least partly of an elastocaloric material.

28. The motor vehicle of claim 27, wherein the coating has a layer thickness of up to 200 μm.

29. The motor vehicle of claim 27, wherein the coating has a layer thickness in the range from 5 μm to 100 μm.

30. The motor vehicle of claim 27, wherein the carrier is reversibly stretchable up to an elastic limit of at least 2%.
